(19) United States
(12) Patent Application Publication
(10) Pub. No.: US 2014/0057046 A1
(43) Pub. Date: Feb. 27, 2014

(54) METHODS FOR FABRICATING ANODES OF LITHIUM BATTERY

(71) Applicants: TSINGHUA UNIVERSITY, Beijing (CN); HON HAI PRECISION INDUSTRY CO., LTD., New Taipei (TW)

(72) Inventors: YANG WU, Beijing (CN); XING-FENG HE, Beijing (CN); JIA-PING WANG, Beijing (CN); KAI-LI JIANG, Beijing (CN); SHOU-SHAN FAN, Beijing (CN)

(73) Assignees: HON HAI PRECISION INDUSTRY CO., LTD., New Taipei (TW); TSINGHUA UNIVERSITY, Beijing (CN)

(21) Appl. No.: 13/869,939

(22) Filed: Apr. 24, 2013

(30) Foreign Application Priority Data
Aug. 22, 2012 (CN) 2012103002368

(51) Int. Cl. H01M 4/04

(52) U.S. Cl. CPC H01M 4/0423
USPC 427/113

(57) ABSTRACT

A method for fabricating the anode of the lithium battery is related. A carbon nanotube film structure is provided. A metal layer is deposited on the carbon nanotube film structure by vacuum evaporating method. The metal layer deposited on the carbon nanotube film structure is oxidized spontaneously.

### CROSS-REFERENCE TO RELATED APPLICATIONS

This application claims all benefits accruing under 35 U.S.C. §119 from China Patent Application No. 201210300236.8, filed on Aug. 22, 2012 in the China Intellectual Property Office, the disclosure of which is incorporated herein by reference. This application is related to applications entitled, “ANODES OF LITHIUM BATTERY”, filed **** (Atty. Docket No. US45586).

### BACKGROUND

1. Technical Field

The present invention relates to methods for fabricating anodes of lithium batteries.

2. Discussion of Related Art

In recent years, lithium batteries have received a great deal of attention. Lithium batteries are used in various portable devices, such as notebook PCs, mobile phones, and digital cameras because of their small weight, high discharge voltage, long cyclic life, and high energy density compared with conventional lead storage batteries, nickel-cadmium batteries, nickel-hydrogen batteries, and nickel-zinc batteries.

A conventional method for making an anode of lithium battery includes steps of: providing an anode active material, a number of conductive particles and a binder; mixing the anode active material, the conductive particles and the binder together to form a slurry; shaping and baking the slurry to form the anode of lithium battery. However, the conductive particles are prone to aggregation, as such, the performance of the anode of the lithium battery will be decreased.

What is needed, therefore, is to provide a method for making an anode of a lithium battery, which can overcome the above-described shortcomings.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 shows a flow chart of one embodiment of a method for fabricating the anode of the lithium battery.

FIG. 2 is a scanning electron microscope (SEM) image of a drawn carbon nanotube film.

FIG. 3 is an SEM image of a pressed carbon nanotube film.

FIG. 4 is an SEM image of a flocculated carbon nanotube film.

FIG. 5 shows a schematic structural view of one embodiment of depositing a metal material on a carbon nanotube film structure of FIG. 1.

FIG. 6 is an SEM image of one embodiment of an anode of the lithium battery.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

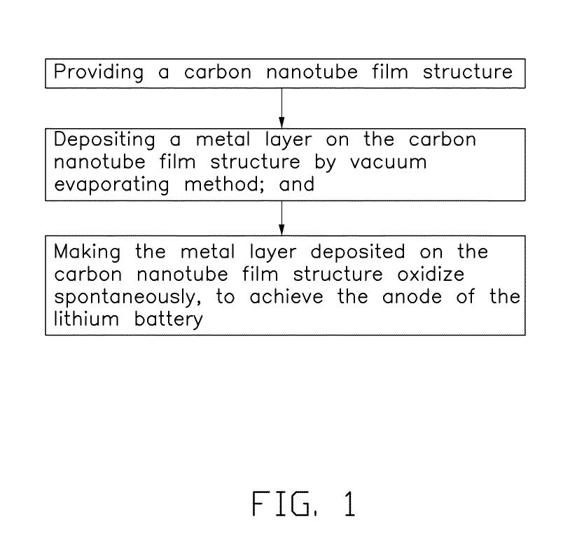

Referring to FIG. 1, a method for fabricating an anode of a lithium battery includes the steps of: (S 10) providing a carbon nanotube film structure; (S 11) depositing a metal layer on the carbon nanotube film structure by vacuum evaporating method; and (S12) making the metal layer deposited on the carbon nanotube film structure oxidize spontaneously.

In step (S10), the carbon nanotube film structure can be a free-standing structure, that is, the carbon nanotube film structure can support itself without a substrate. For example, if at least one point of the carbon nanotube film structure is held, the entire carbon nanotube film structure can be lifted without being damaged. The carbon nanotube film structure can include a plurality of carbon nanotubes. Adjacent carbon nanotubes in the carbon nanotube film structure can be attached to each other by the van der Waals force therebetween. A plurality of micropores can be defined in the carbon nanotube film structure. A thickness of the carbon nanotube film structure can range from about 100 nanometers to about 100 micrometers. In some embodiments, the thickness of the carbon nanotube film structure ranges from about 500 nanometers to about 1 micrometer. A diameter of each of the plurality of carbon nanotubes can range from about 5 nanometers to about 20 nanometers. In some embodiments, the diameter of each of the plurality of carbon nanotubes ranges from about 10 nanometers to about 15 nanometers. In one embodiment, the diameter of each of the plurality of carbon nanotubes is about 10 nanometers. A length of the plurality of carbon nanotubes is not limited. In some embodiments, the length of the plurality of carbon nanotubes ranges from about 100 micrometers to about 900 micrometers.

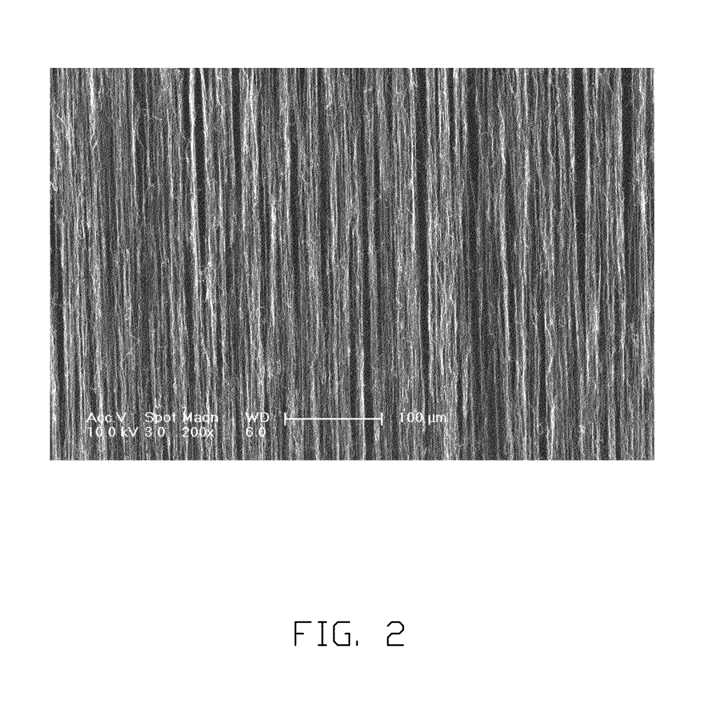

The carbon nanotube film structure can include at least one carbon nanotube film. Referring to FIG. 2, the carbon nanotube film can be a drawn carbon nanotube film formed by drawing a film from a carbon nanotube array. The drawn carbon nanotube film consists of a plurality of carbon nanotubes. The plurality of carbon nanotubes in the drawn carbon nanotube film is arranged substantially parallel to a surface of the drawn carbon nanotube film. A large number of the carbon nanotubes in the drawn carbon nanotube film can be oriented along a preferred orientation, meaning that a large number of the carbon nanotubes in the drawn carbon nanotube film are arranged substantially along a same direction. An end of one carbon nanotube is joined to another end of an adjacent carbon nanotube arranged substantially along the same direction, by van der Waals force, to form a free-standing film. A small number of the carbon nanotubes are randomly arranged in the drawn carbon nanotube film, and have a small if not negligible effect on the greater number of the carbon nanotubes in the drawn carbon nanotube film, that are arranged substantially along the same direction. It can be appreciated that some variation can occur in the orientation of the carbon nanotubes in the drawn carbon nanotube film. Microscopically, the carbon nanotubes oriented substantially along the same direction may not be perfectly aligned in a straight line, and some curved portions may exist. It can be understood that contact between some carbon nanotubes located substantially side by side and oriented along the same direction cannot be totally excluded.

The drawn carbon nanotube film includes a plurality of successively oriented carbon nanotube segments joined end-to-end by van der Waals force therebetween. Each carbon nanotube segment includes a plurality of carbon nanotubes substantially parallel to each other, and joined by van der Waals force therebetween. The carbon nanotube segments can vary in width, thickness, uniformity, and shape. The carbon nanotubes in the drawn carbon nanotube film are also substantially oriented along a preferred orientation. The width of the drawn carbon nanotube film relates to the carbon nanotube array from which the drawn carbon nanotube film is drawn. Furthermore, the carbon nanotube film has an extremely large specific surface area, and is very sticky.

The carbon nanotube film structure can include more than one stacked drawn carbon nanotube film. An angle can exist between the oriented directions of the carbon nanotubes in adjacent films. Adjacent drawn carbon nanotube films can be combined by the van der Waals force therebetween without the need of an adhesive. An angle between the oriented directions of the carbon nanotubes in two adjacent drawn carbon nanotube films can range from about 0 degree to about 90 degrees. The number of layers of the drawn carbon nanotube films in the carbon nanotube film structure is not limited. In some embodiments, the carbon nanotube film structure includes about 1 layer to 5 layers of stacked drawn carbon nanotube films. In one embodiment, the carbon nanotube film structure includes 2 layers of stacked drawn carbon nanotube films, and the angle between the oriented directions of the carbon nanotubes of the two drawn carbon nanotube films is about 90 degrees.

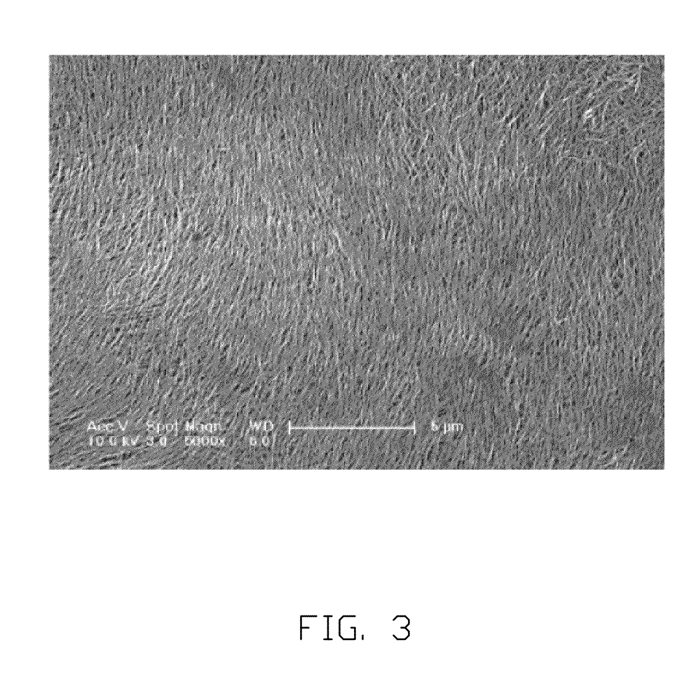

Referring to FIG. 3, the carbon nanotube film can also be a pressed carbon nanotube film formed by pressing a carbon nanotube array down on the substrate. The carbon nanotubes in the pressed carbon nanotube array can be arranged along a same direction or along different directions. The carbon nanotubes in the pressed carbon nanotube array can rest upon each other. Some of the carbon nanotubes in the pressed carbon nanotube film can protrude from a general surface/plane of the pressed carbon nanotube film. Adjacent carbon nanotubes are attracted to each other and combined by van der Waals force. When the carbon nanotubes in the pressed carbon nanotube array are arranged along different directions, the carbon nanotube structure can be isotropic.

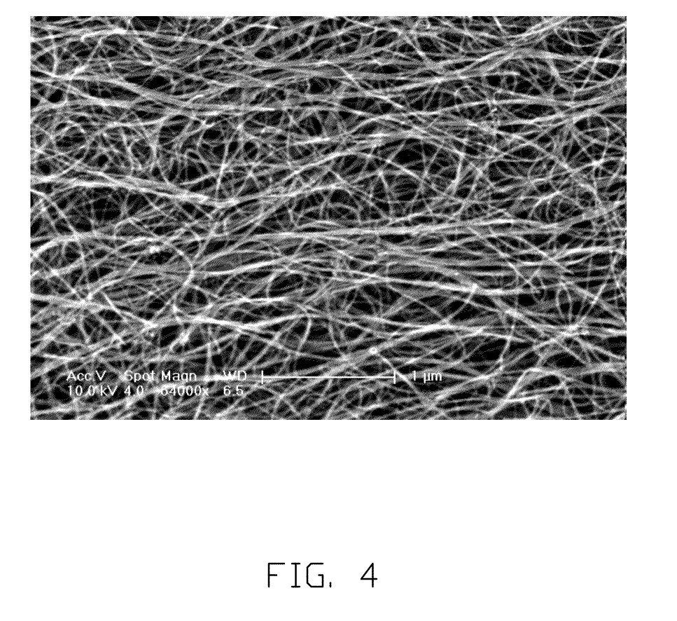

Referring to FIG. 4, the carbon nanotube film can also be a flocculated carbon nanotube film formed by a flocculating method. The flocculated carbon nanotube film can include a plurality of long, curved, disordered carbon nanotubes entangled with each other. The carbon nanotubes can be substantially uniformly distributed in the carbon nanotube film. The adjacent carbon nanotubes are acted upon by the van der Waals force therebetween. Some of the carbon nanotubes in the flocculated carbon nanotube film can protrude from a general surface/plane of flocculated carbon nanotube film.

In step (S11), the step of depositing the metal layer on the carbon nanotube film structure by vacuum evaporating method includes sub-steps of:

S111, providing a metal material;

S112, providing a reactor and locating the carbon nanotube film structure in the reactor;

S113, placing the reactor under a vacuum condition and heating the metal material to from a metal steam, the metal steam agglomerates into the carbon nanotube film structure to form the metal layer.

In step (S111), the metal material can be a transition metal, such as iron, cobalt, manganese, nickel or their alloys. In one embodiment, the metal material is iron.

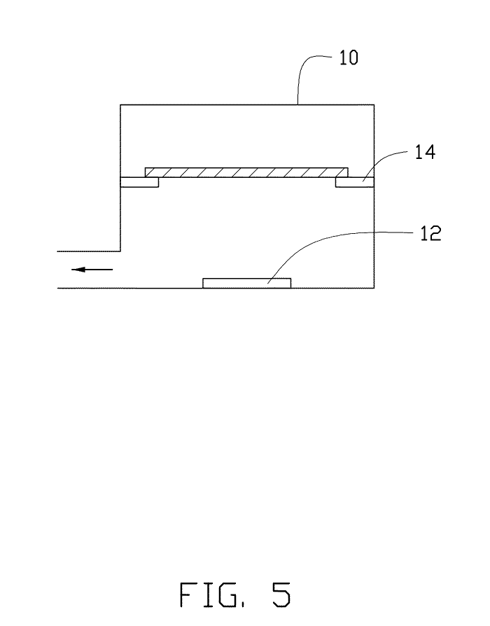

In step (S 112), referring to FIG. 5, the reactor includes a reaction chamber 10, a vacuum pump (not shown), at least one vapor source 12 and at least two supporters 14. The at least one vapor source 12 is located on the bottom of the reaction chamber 10. The at least one vapor source 12 can be used to locate the metal material and heat the metal material to form the metal steam. The at least two supporters 14 are located on the sidewalls of the reaction chamber 10 and used for supporting the carbon nanotube film structure. The carbon nanotube film structure can be suspended over the at least one vapor source 12 by the at least two supporters 14.

In step (S113), the metal material can be heated by the at least one vapor source 12 to form the metal steam. The metal steam can agglomerate into the entire carbon nanotube film structure by the plurality of micropores to form the metal layer on surfaces of the plurality of carbon nanotubes. A vacuum pressure of the reaction chamber 10 can be lower than 10⁻³ Pa, in order to increase a density of the metal steam of the reaction chamber 10. In one embodiment, the vacuum pressure of the reaction chamber 10 is about 4×10⁻³ Pa.

In some embodiment, the metal layer is uniformly coated on the entire surface of each carbon nanotube to form a successive metallic tubular structure. A thickness of the metal layer can be controlled by the depositing time. The thickness of the metal layer can be selected according to the diameter of each of the plurality of carbon nanotubes. The thickness of the metal layer can be 0.5 to 3 times greater than the diameter of each of the plurality of carbon nanotubes, that is, the thickness of the metal layer can be ranged from about 2.5 nanometers to about 60 nanometers. In some embodiments, the thickness of the metal layer is about 1 to 2 times greater than the diameter of each of the plurality of carbon nanotubes. In one embodiment, the thickness of the metal layer is substantially equal to the diameter of each of the plurality of carbon nanotubes. In one embodiment, the metal layer is an iron tubular structure with a thickness of about 10 nanometers.

The step (S12) can be carried out in air. Specifically, the carbon nanotube film structure with the metal layer thereon can be taken out of the reaction chamber 10 and exposed in the air. Because the metal layer has a little thickness, such as thicker than about 60 nanometers, the metal layer on the carbon nanotube film structure can be completely oxidized by air to form a successive metal oxide layer, thus, the anode of the lithium battery is formed. In some embodiments, the metallic tubular structure on surface of each carbon nanotube is completely oxidized by air to form a successive oxidize tubular structure. It is to be noted that, when the thickness of the metal layer is greater than 60 nanometers, the metal layer on the carbon nanotube film structure cannot be completely oxidized by air, thus, the property of the anode of the lithium battery can be decreased.

Furthermore, a capacity and ion/electron transport rate of the anode of the lithium battery is related to the thickness of the metal layer. Specifically, with the increase of the thickness of the metal oxide layer, the anode of the lithium battery can have higher capacity; however, the ion/electron transport rate of the anode of the lithium battery can be decreased. Thus, the thickness of the metal oxide layer should be controlled in order to optimize the performance of the anode of the lithium battery.

The thickness of the metal oxide layer can be controlled by the thickness of the metal layer and can be substantially equal to the thickness of the metal layer. The thickness of the metal oxide layer can be 0.5 to 3 times greater than the diameter of each of the plurality of carbon nanotubes, that is, the thickness of the metal oxide layer can be about 2.5 nanometers to about 60 nanometers. In some embodiments, the thickness of the metal oxide layer is about 1-2 times greater than the diameter of each of the plurality of carbon nanotubes. In one embodiment, the thickness of the metal oxide layer is substantially equal to the diameter of each of the plurality of carbon nanotubes. In one embodiment, the metal oxide layer is a Fe₃O₄ tubular structure with a thickness of about 10 nanometers.

It is to be noted that, when the diameter of each of the plurality of the carbon nanotubes is less than 5 nanometers, the metal layer cannot be uniformly deposited on surface of each carbon nanotube to form the metallic tubular structure, because of a great curvature of the plurality of the carbon nanotubes. Thus, the performance of the anode of the lithium battery can be decreased. Furthermore, when the diameter of each of the plurality of the carbon nanotubes is greater than 20 nanometers, it would be difficult to improve the capacity of the anode of the lithium batter by increasing the thickness of the metal oxide layer. Because when the thickness of the metal oxide layer is greater than 60 nanometers, the ion/electron transport rate of the anode of the lithium batter can be rapidly decreased.

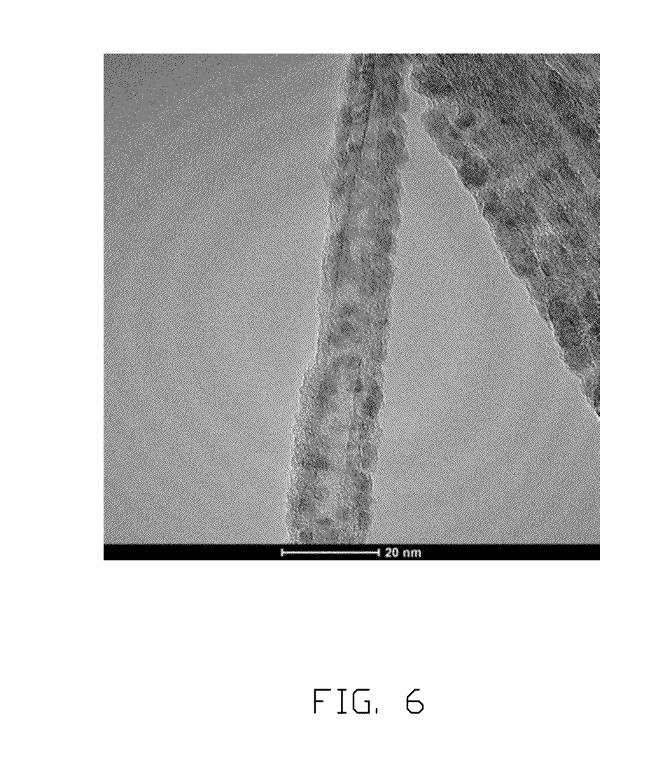

Referring to FIG. 6, an anode of a lithium battery, formed by the above method, includes a carbon nanotube film structure and a Fe₃O₄ layer located in the carbon nanotube film structure. The carbon nanotube film structure includes a plurality of carbon nanotubes having a diameter of about 10 nanometers. The Fe₃O₄ layer is located on surface of each carbon nanotube to form a successive oxidize tubular structure. A thickness of the oxidize tubular structure is about 10 nanometers. A capacity of the anode of a lithium battery is about 1600 mAh/g, which is about 5 times greater than a capacity of a graphite anode (330 mAh/g), and about 2 times greater than a capacity of a pure Fe₃O₄ anode (924 mAh/g).

The anode of the present embodiment includes the carbon nanotube film structure and oxidize tubular structure uniformly deposited on surface of each carbon nanotube. As such, the capacity and ion/electron transport rate of the anode of the lithium battery can be improved due to the optimize thickness of the oxidize tubular structure. Additionally, the method for fabricating the above-described anode of the lithium battery is simple and suitable for mass production.

It is to be understood that the above-described embodiment is intended to illustrate rather than limit the disclosure. Variations may be made to the embodiment without departing from the spirit of the disclosure as claimed. The above-described embodiments are intended to illustrate the scope of the disclosure and not restricted to the scope of the disclosure.

It is also to be understood that the above description and the claims drawn to a method may include some indication in reference to certain steps. However, the indication used is only to be viewed for identification purposes and not as a suggestion as to an order for the steps.

1. A method for fabricating an anode of a lithium battery comprising steps of:
(a) providing a carbon nanotube film structure;
(b) depositing a metal layer on the carbon nanotube film structure by a vacuum evaporating method; and
(c) oxidizing the metal layer deposited on the carbon nanotube film structure spontaneously.

2. The method as claimed in claim 1, wherein step (b) comprises the sub-steps of:
(b1) providing a metal material and a reactor;
(b2) locating the carbon nanotube film structure in the reactor; and
(b3) placing the reactor in a vacuum condition and heating the metal material to from a metal steam, and the metal steam agglomerates into the carbon nanotube film structure.

3. The method as claimed in claim 2, wherein the metal material comprises a transition metal.

4. The method as claimed in claim 2, wherein the metal material comprises a material selected from a group consisting of iron, cobalt, manganese, nickel and their alloys.

5. The method as claimed in claim 2, wherein a vacuum pressure of the reactor is lower than 10⁻³ Pa.

6. The method as claimed in claim 1, wherein the metal layer deposited on the carbon nanotube film structure is oxidized spontaneously in air.

7. The method as claimed in claim 1, wherein the carbon nanotube film structure comprises a plurality of carbon nanotubes.

8. The method as claimed in claim 7, wherein a diameter of each of the plurality of carbon nanotube ranges from about 5 nanometers to about 20 nanometers.

9. The method as claimed in claim 7, wherein a diameter of each of the plurality of carbon nanotube ranges from about 10 nanometers to about 15 nanometers.

10. The method as claimed in claim 7, wherein the metal layer is deposited on surface of each carbon nanotube to from a successive metallic tubular structure.

11. The method as claimed in claim 10, wherein the successive metallic tubular structure is oxidized spontaneously to form a successive oxidize tubular structure on each carbon nanotube.

12. The method as claimed in claim 10, wherein a thickness of the successive metallic tubular structure is about 0.5 to 3 times greater than a diameter of each of the plurality of carbon nanotubes.

13. The method as claimed in claim 10, wherein a thickness of the successive metallic tubular structure is about 1 to 2 times greater than a diameter of each of the plurality of carbon nanotubes.

14. The method as claimed in claim 1, wherein a thickness of the carbon nanotube film structure ranges from about 100 nanometers to about 100 micrometers.

15. The method as claimed in claim 14, wherein the thickness of the carbon nanotube film structure ranges from about 500 nanometers to about 1 micrometers.

16. The method as claimed in claim 1, wherein the carbon nanotube film structure comprises at least two overlapped carbon nanotube films.

17. The method as claimed in claim 16, wherein each carbon nanotube film consists of a plurality of carbon nanotubes arranged substantially along a same direction.

18. The method as claimed in claim 17, wherein an end of each carbon nanotube is joined to another end of an adjacent carbon nanotube along an arranged direction of the plurality of carbon nanotubes by van der Waals force.
